(19) United States
(12) Patent Application Publication
(10) Pub. No.: US 2019/0075166 A1
(43) Pub. Date: Mar. 7, 2019

(54) Methods, Systems and Devices for Monitoring and/or Managing Network-Connected Device Usage

(71) Applicant: The Toronto-Dominion Bank, Toronto (CA)

(72) Inventors: Rajeev Kumar Gandhi, Toronto (CA); Julie Anne Cassidy, Toronto (CA); Ann Cynthia Eapen, Toronto (CA); John Jong-Suk Lee, Toronto (CA); Rakesh Thomas Jethwa, Toronto (CA)

(21) Appl. No.: 15/695,751

(22) Filed: Sep. 5, 2017

(51) Int. Cl. H04L 29/08; H04L 12/26

(52) U.S. Cl. CPC H04L 67/125; H04L 67/104; H04L 43/0817; H04L 43/0811

(57) ABSTRACT

This application provides for managing usage of network-connected device(s) over a network. Some aspects provide: determining, for at least one network-connected device, altered device setting(s) feasible for an allocation amount; and sending a signal to each network-connected device affected by the altered device setting(s) to cause each affected network-connected device to operate in accordance with the respective altered device setting(s). Once each affected network-connected device is operating in accordance with the respective altered device setting(s), adjustment of device setting(s) of one or more of the network-connected device(s), such that the allocation amount is no longer feasible, causes to be determined a further adjustment of one or more others of the device settings to maintain feasibility of the allocation amount. When an amount of the adjustment is such that the allocation amount cannot be met by the further adjustment, a variance from the allocation amount is determined.

### TECHNICAL FIELD

The following relates generally to methods and devices for monitoring and/or managing usage of network-connected devices. More specifically, the following relates to methods and devices for monitoring and/or managing usage of network-connected devices in accordance with allocations.

### BACKGROUND

Increasingly, devices, machines, and the like, such as automobiles, light fixtures, and refrigerators, are becoming network-connected devices to allow for their management (such as by, e.g., turning a device on or off, adjusting power output, updating firmware or software, etc.). Such network-connected devices may be connected to any wired or wireless network of any type or size, including the Internet. The recent emergence of network-connected devices has resulted in a networked “web” of devices known as the “Internet of Things” (IoT). In order to, among other things, help manage household budgets or other types of allocations, such as power or energy consumption budgets, there is a need for a real-time ability to monitor and/or manage the usage of network-connected device(s). Furthermore, altering device settings of multiple network-connected devices in order to make feasible a budget or allocation can be a burdensome and time-consuming task, requiring constant monitoring in order to tweak settings as needed, which in turn may result in delays and inefficiencies in adjusting settings.

### SUMMARY

In an aspect of the present application there is provided a computing device for managing usage of network-connected device(s) over a network. The computing device comprises: a memory storing computer-executable instructions; a communication module for communication with the network-connected device(s) via the network; and at least one processor coupled to the memory and the communication module. The instructions when executed by the at least one processor cause the at least one processor to: determine, for at least one of the network-connected device(s), altered device setting(s) feasible for an allocation amount relating to the network-connected device(s), the allocation amount pertaining to a time period; and send, via the communication module, over the network, a signal to each of the at least one of the network-connected device(s) affected by the determined altered device setting(s), each of the signal(s) causing each of the affected network-connected device(s) to operate in accordance with the respective altered device setting(s). Once each of the affected network-connected device(s) is operating in accordance with the respective altered device setting(s), adjustment of one or more device setting(s) of one or more of the network-connected device(s) such that the allocation amount is no longer feasible causes to be determined a further adjustment of one or more others of the device setting(s) of the network-connected device(s) to maintain feasibility of the allocation amount. When an amount of the adjustment of the one or more device setting(s) of the one or more of the network-connected device(s) is such that the allocation amount cannot be met by the determined further adjustment of the one or more others of the device setting(s) of the network-connected device(s), a variance from the allocation amount is determined.

In another aspect of the present application there is provided a system for managing usage of network-connected device(s) over a network. The system comprises: a computing device; and the network-connected device(s). The computing device comprises: a memory storing computer-executable instructions; a communication module for communication with the network-connected device(s) via the network; and at least one processor coupled to the memory and the communication module. The instructions when executed by the at least one processor cause the at least one processor to: determine, for at least one of the network-connected device(s), altered device setting(s) feasible for an allocation amount relating to the network-connected device(s), the allocation amount pertaining to a time period; and send, via the communication module, over the network, a signal to each of the at least one of the network-connected device(s) affected by the determined altered device setting(s), each of the signal(s) causing each of the affected network-connected device(s) to operate in accordance with the respective altered device setting(s). Once each of the affected network-connected device(s) is operating in accordance with the respective altered device setting(s), adjustment of one or more device setting(s) of one or more of the network-connected device(s) such that the allocation amount is no longer feasible causes to be determined a further adjustment of one or more others of the device setting(s) of the network-connected device(s) to maintain feasibility of the allocation amount. When an amount of the adjustment of the one or more device setting(s) of the one or more of the network-connected device(s) is such that the allocation amount cannot be met by the determined further adjustment of the one or more others of the device setting(s) of the network-connected device(s), a variance from the allocation amount is determined. The network-connected device(s) are connected to each other in a peer-to-peer manner, and each of the network-connected device(s) comprises: a device memory storing computer-executable instructions; a device communication module for communication with the computing device and one or more others of the network-connected device(s), via the network; and at least one device processor coupled to the device memory and the device communication module. The further adjustment is determined and executed by the instructions when executed by the at least one device processor of the one or more of the network-connected device(s) for which the one or more device setting(s) are adjusted.

In yet another aspect of the present application there is provided a method for managing usage of network-connected device(s) over a network by a computing device. The computing device comprises at least one processor coupled to a memory and a communication module. The method comprises: determining, for at least one of the network-connected device(s), altered device setting(s) feasible for an allocation amount relating to the network-connected device(s), the allocation amount pertaining to a time period; and sending, via the communication module, over the network, a signal to each of the at least one of the network-connected device(s) affected by the determined altered device setting(s), each of the signal(s) causing each of the affected network-connected device(s) to operate in accordance with the respective altered device setting(s). Once each of the affected network-connected device(s) is operating in accordance with the respective altered device setting(s), adjustment of one or more device setting(s) of one or more of the network-connected device(s) such that the allocation amount is no longer feasible causes to be determined a further adjustment of one or more others of the device setting(s) of the network-connected device(s) to maintain feasibility of the allocation amount. When an amount of the adjustment of the one or more device setting(s) of the one or more of the network-connected device(s) is such that the allocation amount cannot be met by the determined further adjustment of the one or more others of the device setting(s) of the network-connected device(s), a variance from the allocation amount is determined

In yet a further aspect of the present application there is provided a non-transitory computer-readable medium for managing usage of network-connected device(s) over a network. The computer-readable medium comprises computer-executable instructions for: determining, for at least one of the network-connected device(s), altered device setting(s) feasible for an allocation amount relating to the network-connected device(s), the allocation amount pertaining to a time period; and sending, over the network, a signal to each of the at least one of the network-connected device(s) affected by the determined altered device setting(s). Each of the signal(s) causes each of the affected network-connected device(s) to operate in accordance with the respective altered device setting(s). Once each of the affected network-connected device(s) is operating in accordance with the respective altered device setting(s), adjustment of one or more device setting(s) of one or more of the network-connected device(s) such that the allocation amount is no longer feasible causes to be determined a further adjustment of one or more others of the device setting(s) of the network-connected device(s) to maintain feasibility of the allocation amount. When an amount of the adjustment of the one or more device setting(s) of the one or more of the network-connected device(s) is such that the allocation amount cannot be met by the determined further adjustment of the one or more others of the device setting(s) of the network-connected device(s), a variance from the allocation amount is determined.

### BRIEF DESCRIPTION OF THE DRAWINGS

Aspects of the application will now be described by way of example only with reference to the appended drawings in which:

FIG. 1 depicts a schematic diagram of an exemplary aspect of a system described herein;

FIG. 2 depicts a schematic diagram of an exemplary aspect of a computing device described herein;

FIG. 3 depicts a schematic diagram of an exemplary aspect of a smart sensor described here;

FIG. 4 depicts a schematic diagram of another exemplary aspect of a system described herein;

FIG. 5 depicts a flow diagram of an exemplary aspect of computer-executable instructions described herein;

FIG. 6 depicts a schematic diagram of an exemplary aspect of a server described herein;

FIG. 7 depicts a flow diagram of another exemplary aspect of computer-executable instructions described herein;

FIG. 8 depicts a schematic diagram of an exemplary aspect of a network-connected device described herein;

FIG. 9 depicts a flow diagram of another exemplary aspect of computer-executable instructions described herein; and

FIG. 10 depicts a flow diagram of another exemplary aspect of computer-executable instructions described herein.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the exemplary aspects of the present application described herein. However, it will be understood by those of ordinary skill in the art that the exemplary aspects described herein may be practised without these specific details. In other instances, well-known methods, procedures and components have not been described in detail so as not to obscure the exemplary aspects described herein. Also, the description is not to be considered as limiting the scope of the exemplary aspects described herein. Any systems, method steps, components, parts of components, and the like described herein in the singular are to be interpreted as also including a description of such systems, method steps, components, parts of components, and the like in the plural, and vice versa.

Network-connected objects, devices, machines, things, etc., connected to a network such as the Internet, are typically capable of collecting and sharing data with other connected devices or servers using any of the communication protocols that have been developed for or that are suitable for use or usable with IoT devices, such as more traditional web protocols like TCP/IP, and newer protocols catered to IoT device communication, such as Constrained Application Protocol (CoAP) or Message Queue Telemetry Transport (MQTT).

In order to help manage allocations, such as household budgets, there is a need for a real-time ability to monitor and manage the usage of one or more network-connected devices, including, for example, appliances such as clothes washers and dryers, dishwashing machines, slow-cookers, and the like, and other devices such as furnaces, fireplaces, refrigerators, light fixtures, water tanks, thermostats, and any other electricity-, water- or gas-(collectively, “utility”) consuming device.

It can be difficult to manage allocations, such as budgets (of any kind, including financial budgets, and power or energy consumption budgets), and in particular, the costs associated with the use of devices that consume such utilities. Part of the difficulty in managing these costs is that utilities are typically billed in arrears, and as such, budgetary adjustments for a budget tend to be reactionary, based on the prior billing cycle and the usage demands of that prior billing cycle's timeframe. For example, while the month of March may incur a high electricity or gas bill due to increased heating of a home, the month of April may require less heating in order to maintain the same home temperature, due to rising environmental temperatures. It can be difficult to work towards a budget in a reactionary manner as the coming period may impose different conditions and thus necessitate different device usage patterns, and further, waiting until the completion of a billing cycle to determine budgetary adjustments means that the excess device use has already taken place, and the related costs already incurred. Furthermore, while some people may prefer to cut costs by reducing, for example, their use of lighting, others may prefer to reduce water or gas use, so there is no “one size fits all” solution for reducing the costs associated with the use of such devices.

A user of such devices may have or have access to (e.g., through a web portal) a software application from a financial institution, such as a bank, which monitors monetary debit and credit transactions in accounts of the user, aggregates and sorts the monitored account data, and provides to the user a report of the user's financial transactions for a certain time period. For example, such reports may show income and expenditures on a monthly basis, aggregated by industry or type (e.g., amount spent on food, gasoline, clothing, etc.). Such applications may also provide a mechanism for establishing a budget for a certain time period, in which case the reports may include information on whether a budget has been met, including information on the extent of variance from a budget. However, these applications do not account for real-time expenditures related to the use of network-connected devices, nor do they provide real-time budget tracking accounting for such usage of network-connected devices.

The present description generally relates to methods, systems and devices for monitoring and/or managing network-connected device usage in accordance with allocations. An allocation may be any manually or automatically pre-determined threshold for a parameter that affects the usage of one or more network-connected devices. As a non-limiting example, an allocation may include a maximum or minimum amount of gasoline consumption or distance of travel per day for a network-connected automobile. Other non-limiting examples of an allocation may include an amount of electricity usage, an amount of water usage, an amount of natural gas usage, an amount of power or energy consumption, or any combination thereof for, for example, appliances, devices, apparatuses, and the like. As a further non-limiting example, an allocation may include an amount of money spent as a result of usage of appliances. An allocation may be applied as a minimum or a maximum threshold, depending on the circumstances. For example, an automobile testing company may require that test vehicles on the Internet-of-Things (IoT) be road-tested for a certain minimum distance per unit of time, such as at least 100 miles/day. It will be appreciated by the person skilled in the art that there may be many other examples of allocations that may serve to affect the usage of one or more network-connected devices, and that the present disclosure and appended claims are not to be limited by the specific types or examples of allocations described herein.

As used herein, the term “device” includes any device, machine, object, thing, or the like. As also used herein, the term “network-connected device” includes any device configured for, or capable of being adapted for, connection to a network, such as network-connected devices on the IoT. It will be appreciated by the person skilled in the art that while certain network-connected devices presently exist, others may emerge in the future, and that the present disclosure includes all such network-connected devices and is in no way limited by the types of devices presently known by the skilled person to be connectable to a network. Furthermore, the person of skill in the art will appreciate that there are delays inherent to any form of communication, including wired or wireless digital communication, including over a digital network, and as such, as used herein, the term “real-time” includes real-time and substantially real-time communication.

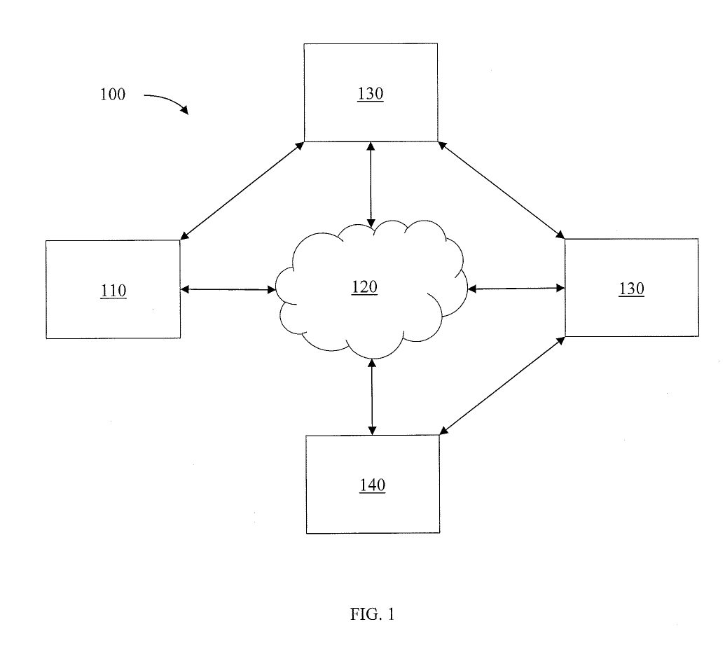

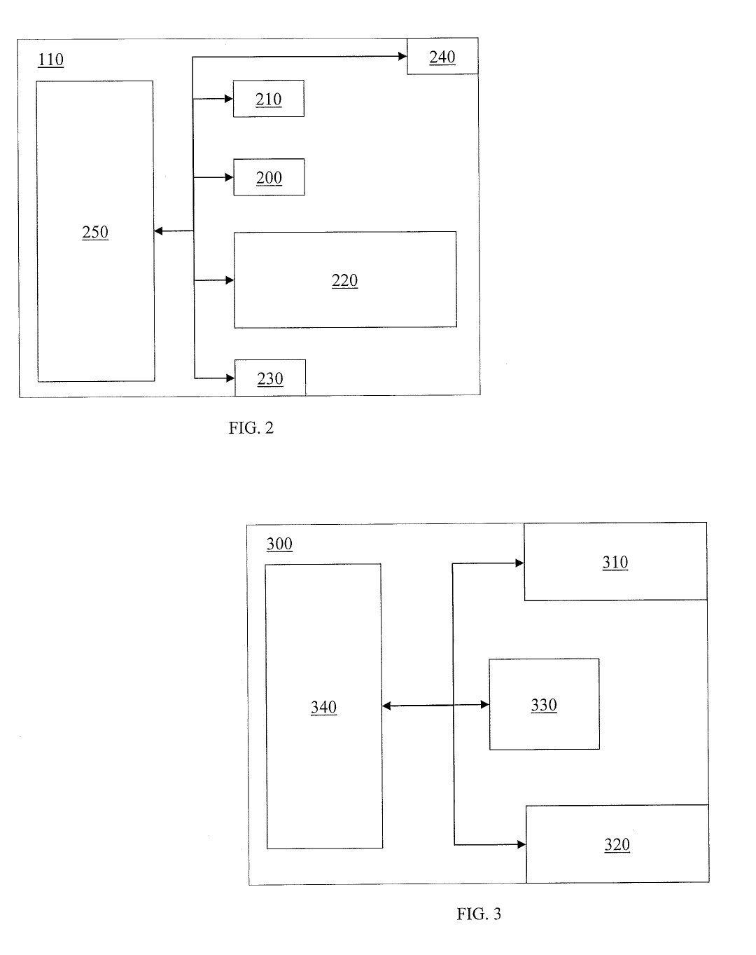

As a non-limiting example, in order to help manage a household budget, there is a need for a real-time ability to monitor and manage the usage of one or more network-connected devices, including, for example, appliances such as clothes washers and dryers, dishwashing machines, slow-cookers, and the like, and other devices such as furnaces, fireplaces, refrigerators, light fixtures, water tanks, thermostats, and any other electricity-, water- or gas-(collectively, “utility”) consuming device. With reference to FIG. 1 and FIG. 2, system 100 includes one or more computing device(s) 110 for monitoring and/or managing the usage of one or more network-connected device(s) 130 over a network 120. Device(s) 130 may communicate with other components of system 100 (e.g., computing device(s) 110, smart sensor(s) 300, server(s) 140, and/or other network-connected device(s) 130) (as described further below)) directly, or indirectly, over network 120, via any of the network types and communication protocols described herein.

Computing device 110 may comprise memory 200, communication module 210, a display 220, one or more input devices 230, one or more sensors 240, and at least one processor 250 coupled to the memory 200, communication module 210, display 220, input device(s) 230, and sensor(s) 240. Communication module 210 enables computing device 110 to communicate with one or more other components of system 100, such as one or more network-connected devices 130, via a wired or wireless communication network, such as network 120. Network 120 may comprise a direct link between communicating components of system 100, or an indirect one, including but not limited to communication by Ethernet™, Bluetooth™, WiFi™, ZigBee™, Z-Wave™, 6LowPAN™, Thread™, NFC (near-field communication), SigFox™, infrared, WiMAX™ (fixed or mobile), RFID (radio-frequency identification), Neul™, LoRaWAN™, CoAP (Constrained Application Protocol), MQTT (Message Queue Telemetry Transport), and any suitable cellular communications protocols including, but not limited to, up to 5G protocols, such as GSM, GPRS, EDGE, CDMA, UMTS, LTE, LTE-A, IMS, for example, and any other communications protocols suitable for the method(s), system(s) and device(s) described herein, including any proprietary protocols. Network 120 may comprise a single network or more than one interconnected network, of any type suitable for the method(s), system(s) and device(s) described herein, including but not limited to wired or wireless PANs (personal area networks), LANs (local area networks), WANs (wide area networks), MANs (metropolitan area networks), mesh or ad hoc networks, VPNs (virtual private networks), the Internet, and any other suitable network type, in any suitable network configuration or topology (e.g., mesh, token ring, tree, star, etc.). Although not shown in FIG. 1, system 100 may further include any components necessary to effect the communication and/or network type(s) used, and may also include components for increased network security, for example, access points, routers, and firewalls.

As used herein, the term “memory”, or any variation thereof, may refer to memories 200, 330, 610, and/or 800). Any such memory may comprise a tangible and non-transitory computer-readable medium (i.e., a medium which does not comprise only a transitory propagating signal per se) comprising or storing computer-executable instructions, such as computer programs, sets of instructions, code, software, and/or data for execution of any method(s), step(s) or process(es) described herein by any processor(s) and/or microcontroller(s) described herein, including processor(s) 250, server processor(s) 620, device processor(s) 850, and/or microcontroller(s) 340 (described further below). As used herein, the terms “processor”, “processors” or “processor(s)” may refer to any combination of processor(s) 250, server processor(s) 620, device processor(s) 850, and/or microcontroller(s) 340 suitable for carrying out method step(s) described herein. Memory may comprise one or more of a local and/or remote hard disk or hard drive, of any type, ROM (read-only memory) and/or RAM (random-access memory), buffer(s), cache(s), flash memory, optical memory (e.g., CD(s) and DVD(s)), and any other form of volatile or non-volatile storage medium in or on which information may be stored for any duration. Such computer-executable instructions, when executed by the processor(s) of computing device(s) 110, server 140, network-connected device(s) 130, and/or smart sensor(s) 300 (described further below) cause the processor(s) to perform any of the methods described herein, such as methods for monitoring and/or managing usage of network-connected device(s) 130 over network 120. It will be appreciated that the method steps described herein may be implemented in a variety of programming languages.

As used herein, the term “input device” or “input interface” (or any variation thereof or like term) may refer to any input device(s) of computing device 110 (input device(s) 230) and/or input device(s) of any other system component 130, 140, 300 (not shown)). The input device(s) provide a mechanism for a user of system 100 (such as, a user of computing device 110 or any other system component 130, 140, 300), to provide input(s), such as during the execution of computer programs stored in memory. Input device(s) may include a touch-sensitive display, physical or virtual keyboard, keypad, mouse, microphone, trackpad, scroll wheel or ball, or other suitable device capable of receiving or detecting an input. Display 220 may comprise any screen suitable for displaying visual information, including any suitable touch-sensitive display, such as a capacitive, resistive, infrared, surface acoustic wave (SAW) touch-sensitive display, strain gauge, optical imaging, dispersive signal technology, acoustic pulse recognition, and so forth, as is known in the art. In such cases display 220 may also serve as an input device 230 of computing device 110.

Sensor(s) 240 (and any other sensor described herein) may include an array of redundant sensors, and may comprise smart sensor(s) having onboard signal and data-processing capabilities, such as a microprocessor and other components, including band pass filters, amplifiers, and any other components which may be used to improve the quality of a received signal (such as by filtering out noise) before relaying information from the signals received to processor(s) for additional processing or interpretation. In some aspects, and with reference to FIG. 3, computing device 110 may include a smart sensor 300 having a transceiver 310 (or a separate transmitter and receiver), sensor(s) 320, memory 330, and a microcontroller 340 coupled to the transceiver (or transmitter and receiver), sensor, and memory, and the memory may comprise or have stored thereon or therein computer-executable instructions that when executed carry out method step(s) described herein. In such aspects of the present application, method steps described herein requiring user input may be carried out through a client interface, such as a web portal, on any networked device, such as a tablet or desktop computer. Furthermore, while in certain aspects a software application running on computing device(s) 110 and/or smart sensor(s) 300 (or any other suitable system component(s), such as network-connected device(s) 130) may interact with a separate software application running on server 140 in order to carry out method step(s) described herein, in other aspects, the software application running on computing device(s) 110 and/or smart sensor(s) 300 (or any other suitable system component(s), such as network-connected device(s) 130) may be a client instance of a software application running on server 140.

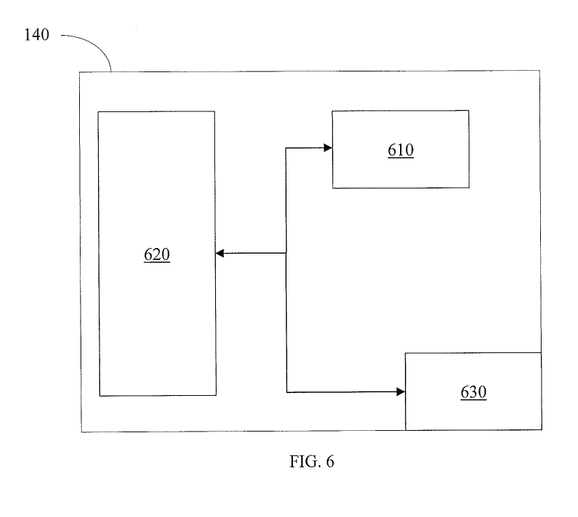

Referring to FIG. 6, server 140 has a server memory 610 comprising instructions that when executed by server processor(s) 620 cause the server processor(s) (and/or, in a distributed processing system, any of processor(s) 250, device processor(s) 850 and/or microcontroller(s) 340) to carry out method step(s) described herein. Server 140 may further comprise other standard components as would be known by the skilled person in the art, such as server communication module 630 for communication with other connected devices or system components over network 120 by any known communication mechanisms, including those described herein.

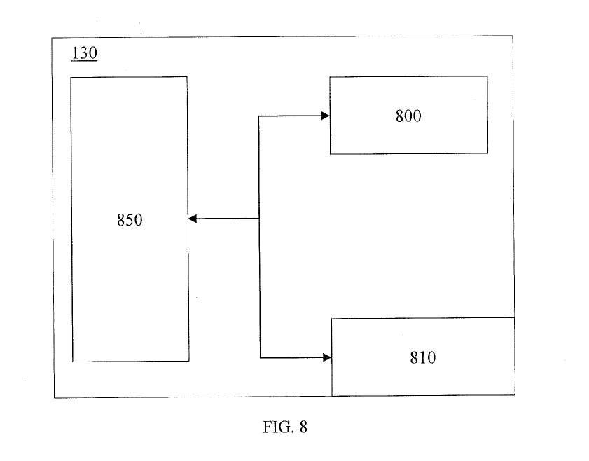

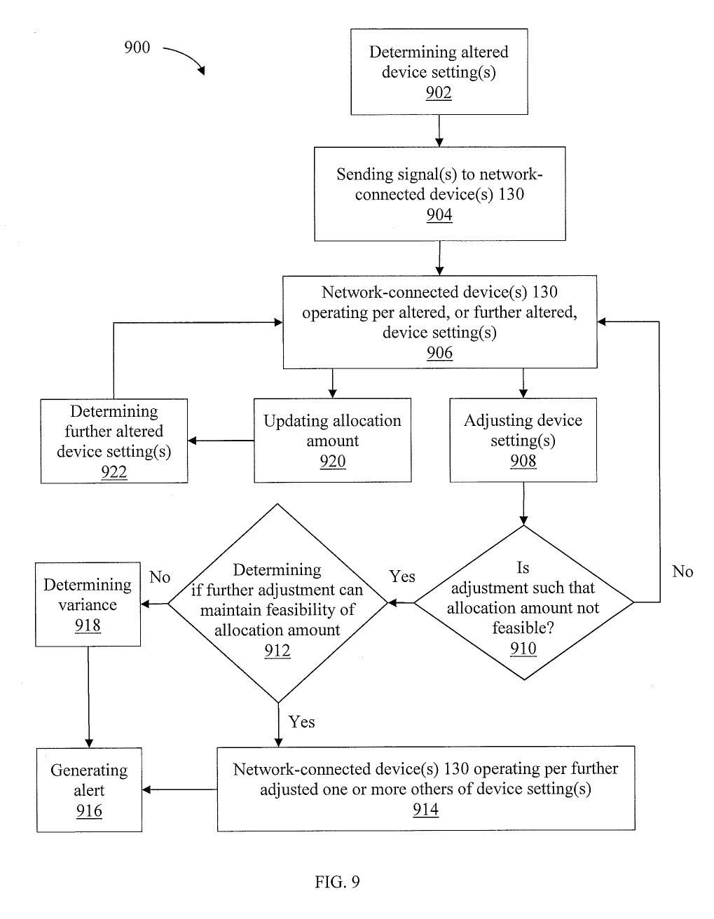

As shown in FIG. 8, each network-connected device 130 may comprise device memory 800, device communication module 810 (for communication, via network 120, with other components of system 100, including computing device(s) 110, server(s) 140, smart sensor(s) 300, and/or one or more other(s) of the network-connected device(s) 130), and at least one device processor 850 coupled to the device memory 800 and device communication module 810. Network-connected device 130 may also include one or more of the components of computing device 110, such as a display, one or more input devices, and one or more sensors (not shown). The components of network-connected device 130 are as described herein for the like components of computing device 110, mutatis mutandis.

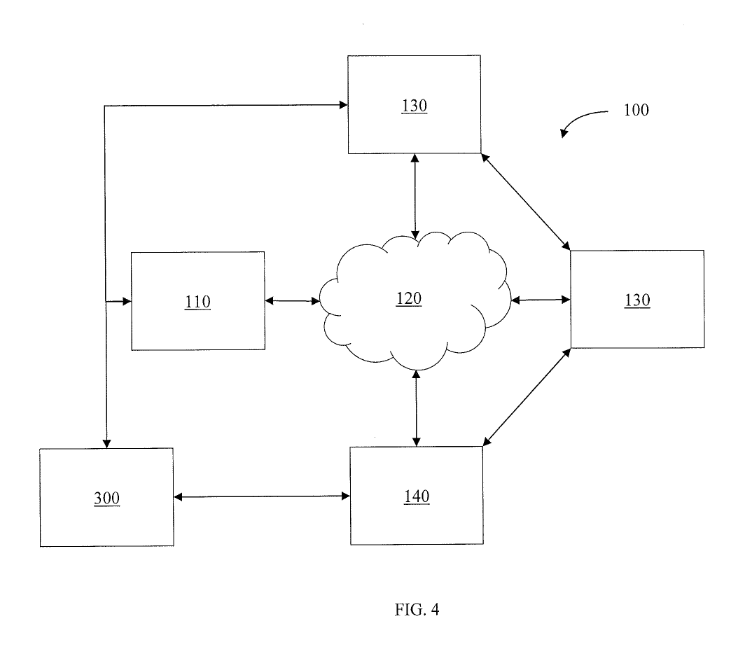

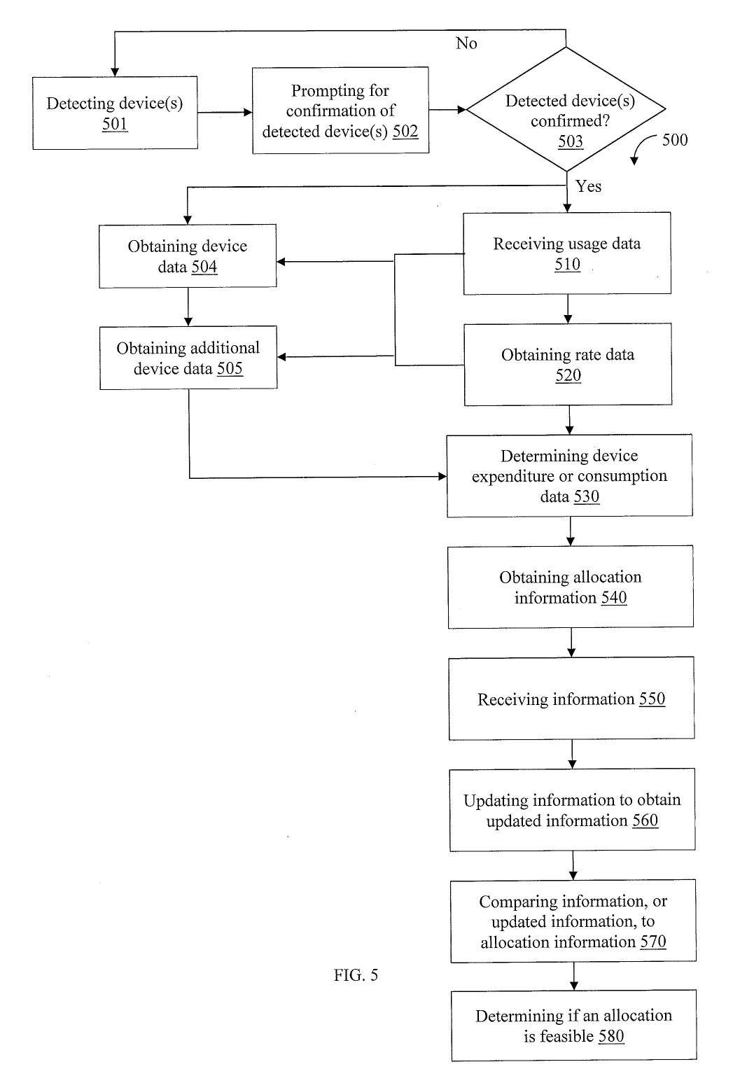

With reference to FIG. 4, system 100 may further comprise smart sensor(s) 300, which may be communicatively coupled to computing device(s) 110, server(s) 140 and/or network-connected device(s) 130. It will be appreciated that any combination of computing device(s) 110, smart sensor(s) 300 and network-connected device(s) 130 may comprise sensors. For example, computing device 110 may comprise no sensors, with only smart sensor(s) 300 comprising sensor(s). Further, the method steps described herein may be carried out by any suitable combination of computing device(s) 110, smart sensor(s) 300, network-connected device(s) 130, and/or server(s) 140. It will further be appreciated that the computer-executable instructions described herein may reside within or on memory 200 of computing device(s) 110, memory 330 of smart sensor(s) 300, device memory 800 of network-connected device(s) 130, or server memory 610 of server(s) 140, or may be distributed amongst any combination of memory 200, 330, 800, and/or 610. Furthermore, it will be appreciated that smart sensor(s) 300 may communicate with computing device(s) 110 only, and/or with other smart sensor(s) 300, network-connected device(s) 130 and/or server(s) 140.

Sensor(s) 240, 320, and any other sensors of system 100, including of network-connected device(s) 130, may comprise presence or proximity sensors, detection and ranging (DAR) sensors, speed measurement sensors, volumetric sensors, electrical usage sensors, gas usage sensors, water usage sensors, and any other sensor type suitable for use with the method(s) described herein. It will be appreciated that network-connected device(s) 130 may comprise the instructions or logic necessary to monitor their own usage (of, e.g., electricity, gas or water) and convey this information to computing device(s) 110 and/or server(s) 140, and that such information may be pushed from device(s) 130 or pulled therefrom by computing device(s) 110 and/or server(s) 140. In such cases, it may not be necessary for computing device(s) 110 to include sensor(s) 240, or for system 100 to comprise smart sensor(s) 300. As described above, network-connected device(s) 130 may also include sensor(s) (not shown) for detecting other network-connected device(s) 130 and/or environmental conditions, such as changes in ambient temperature.

Server(s) 140 of system 100 may represent a system of known components, including additional servers, databases, I/O devices, access terminals, communications pathways, and any other components necessary in order for server(s) 140 to effect method step(s) described herein, as would be known to the person of skill in the art. System 100 may also comprise additional servers 140 for redundancy. As a non-limiting example, server 140 may comprise and communicate to computing device(s) 110, network-connected device(s) 130 and/or smart sensor(s) 300 (by pushing or having pulled therefrom) allocation information of any kind suitable for the method(s) described herein. As a non-limiting example, a server 140 may be a financial server hosting a financial software application of a financial institution, such as a bank, and a user of system 100, including of computing device(s) 110, network-connected device(s) 130 and/or smart sensor(s) 300, may have or have access to (e.g., through a client web portal or an “app” on computing device 110 or on another device (e.g., a mobile device) of the user) the financial application hosted by server 140. Such financial application may monitor monetary debit and credit transactions in accounts of the user, aggregate and sort the monitored account data, and provide to the user a report of the user's financial transactions for a certain time period. For example, such reports may show income and expenditures on a monthly basis, aggregated and sorted by industry or type (e.g., amount spent on food, gasoline, clothing, etc.). Such applications may also provide a mechanism for establishing a budget for a certain time period, in which case the reports may include information on whether a budget has been met, including information on the extent of variance from a budget. In such cases, allocation information may include an allocation that is a budget established by the user for a certain time period (e.g., monthly) using the financial application of server 140. As another example, the allocation may be an average or otherwise determined expenditure amount for a time period (e.g., average monthly expenditures) automatically determined by the financial application. As such, the allocation information, financial information and the one or more accounts may each be associated with a user of the computing device(s) 110, network-connected device(s) 130 and/or smart sensor(s) 300, and the financial information may thus include credit and/or debit information for the account(s) of the user. Allocation information may also include, for example, an amount of overall power or energy consumption for a certain time period (e.g., hourly, monthly) for one or more network-connected device(s) 130 (measured, e.g., in kilowatt-hours (kWh)).

Referring to FIG. 5, in accordance with an exemplary aspect of the present application, the instructions when executed by the processor(s) 250, server processor(s) 620, device processor(s) 850, and/or microcontroller(s) 340 cause the processor(s) to carry out steps of method 500, including receiving 510, via a communication module over network 120, usage data associated with at least one of network-connected device(s) 130; obtaining 520 rate data associated with the at least one of the network-connected device(s) 130, which may represent, as an example, a monetary amount per unit time for use of the at least one of the network-connected device(s), although the rate may comprise non-monetary information, such as power or energy consumption per unit time; determining 530, for the at least one of the network-connected device(s) 130, device expenditure data (which may include, for example, device consumption data, including power or energy consumption data for a time period) based on the rate data and the usage data; obtaining 540 allocation information, which may pertain to a time period and which may be in respect of at least the at least one of the network-connected device(s) 130 (such as a financial budget or other type of budget (e.g., an amount of power or energy consumption) for a time period); receiving 550, via a communication module, over network 120, information, which may include data associated with one or more data files, including, as an example only, receiving information from a server 140, such as a server 140 of a financial institution (e.g., a financial server of a bank, in which case the information may comprise financial information, and the one or more data files may include one or more accounts associated with the financial information), or, as a further example, the received information may include power or energy consumption information for a time period from a smart sensor 300, such as a “smart meter”); updating 560 the information (for example, financial information, or power or energy consumption information) with the device expenditure or consumption data for the at least one network-connected device(s) 130, to obtain updated information, such as updated financial information, or updated power or energy consumption information; comparing 570 the updated information (e.g., updated financial information, or updated power or energy consumption information) to the allocation information; and determining 580, based on the comparison of the updated information (e.g., updated financial information, or updated power or energy consumption information) to the allocation information whether an allocation (such as a financial budget or other type of budget (e.g., an amount of power or energy consumption)) indicated by the allocation information for the time period is feasible.

It will be appreciated that in some aspects, one or more of the method steps of method 500 (and methods 700 and 1000, described below) may be combined or omitted. For example, a network-connected device 130 may maintain an internal record of its device consumption data, including, e.g., power or energy consumption information for a time period, in which case steps 510, 520 and 530 may be combined and executed by network-connected device 130 (e.g., where power or energy consumption is being measured). In such a scenario, steps 550 and 560 may be omitted, and step 570 may comprise comparing 570 the information (e.g., power or energy consumption information) to the allocation information.

It will be appreciated that in aspects of the present application not having computing device(s) 110 (such as where network-connected device(s) 130 and/or smart sensor(s) 300 communicate directly with server(s) 140), the steps of method 500 (and methods 700 and 1000, described below) may be accordingly altered to account for the system not having computing device(s) 110. For example, step 550, comprising receiving information, such as financial information, from server 140 over network 120 via a communication module (communication module 210 where the method is carried out by computing device 110), may not require the receiving of the information to take place over the network 120, nor via communication module 210. In such a scenario, the step 550 may comprise the step of obtaining information, for example financial information, or power or energy consumption information, including data associated with one or more accounts (e.g., budget information).

Still with reference to FIG. 5, where sensor(s) 240 and/or smart sensor(s) 300 are employed and are configured for sensing the at least one network-connected device(s) 130, or where sensor(s) of network-connected device(s) 130 are configured for sensing other network-connected device(s) 130, method 500 may further include the step of detecting 501, via sensor(s) 240, smart sensor(s) 300, or sensor(s) of network-connected device(s) 130, the at least one of the network-connected device(s) 130. The instructions when executed by processor(s) 250, server processor(s) 620, device processor(s) 850, and/or microcontroller(s) 340 may further cause the processor(s) and/or microcontroller(s) to display on display 220 of computing device 110 (or on a display of another device (e.g., a mobile device, computer, tablet, etc.) by which a graphical user interface of an application hosted by server 140, such as the financial application described above, is accessed) a prompt in order to prompt 502 for a confirmation of the detected network-connected device(s). Manual confirmation of detected or otherwise identified network-connected device(s) 130 is expected to reduce the rate of errors in identifying network-connected device(s) 130. At step 503, where the identification of a network-connected device 130 is not confirmed, the instructions may further comprise instructions that when executed cause the respective processor(s) to re-detect 501 or otherwise re-identify the network-connected device 130, and where the identification is confirmed, the method may proceed to step 504. Alternatively, where the network-connected device 130 is itself capable of generating identifying information, the step of detecting 501 may comprise the pushing of such identifying information from the network-connected device 130 to, or the pulling of such identifying information by, server 140, computing device 110, smart sensor(s) 300, and/or another network-connected device 130.

Computing device(s) 110, smart sensor(s) 300, network-connected device(s) 130, and/or server(s) 140 may include instructions on their respective memories 200, 330, 800, 610 which enable processor(s) 240, microcontroller(s) 340, device processor(s) 850, and/or server processor(s) 620 to interpret any communication protocol(s) being used by the network-connected device(s) to obtain 504 and store in memory 200, memory 330, device memory 800, and/or memory 610 device data associated with the network-connected device(s) 130. Such communication protocols may include, for example, any communication protocols designed or suitable for, or capable of use with, the IoT and network-connected device(s) 130 connected to the IoT, including but not limited to those communication types and protocols described herein. Device data may include, for example, usage data and/or rate data for the network-connected device(s) 130. Usage data may include, for example, a number of hours of use, and rate data may include, for example, a financial cost of use per hour, or energy or power consumption per hour. It will be appreciated by the skilled person that other types of usage data and rate data may fall within the scope of the present application, and that usage data and rate data are not to be limited by the specific examples discussed herein.

The instructions when executed by processor(s) 250, server processor(s) 620, device processor(s) 850, and/or microcontroller(s) 340 may also cause the processor(s) and/or microcontroller(s) to display on display 220 of computing device 110 (or on a display of another device (e.g., a mobile device, computer, tablet, etc.) by which a graphical user interface of an application hosted by server(s) 140, such as the financial application described above, is accessed, as would be the case, for example, where the instructions are executed by microcontroller(s) 340 of smart sensor(s) 300) a prompt for entry of additional device data associated with the network-connected device(s) 130, to thereby obtain 505 the additional device data. Whether additional device data is entered or not, method 500 may thereafter proceed to step 530. Additional device data may comprise, for example, one or more of a name, a location and the rate data associated with the network-connected device(s), such as where the rate data does not comprise part of the device data. As an example, where IoT-connected light fixtures are detected by a computing device 110 (or alternatively, their information is pushed to computing device 110 or, e.g., subscribed to by computing device 110 using a communication protocol such as MQTT™), a user may be prompted to enter a name or alias to help the user correctly and more easily identify each such detected light fixture and may, for example, name each detected light fixture “Kitchen Light” and “Family Room Light”. In an alternative aspect of the present application, additional device data may include an optional entry for rate data even where the device data includes rate data, in which case manually entered rate data may override the rate data provided as part of the device data. This is expected to be useful for forecasting expenditures associated with anticipated rate increases, or in situations where it is known that the rate data provided as part of the device data is outdated. In yet a further example aspect of the present application, and with reference to FIG. 1, the rate data associated with the network-connected device(s) 130 may be obtained, for example by computing device 110 and/or server 140, over network 120 from a third party server 150 hosting rate information for the network-connected device(s) 130. Computing device(s) 110 and/or server(s) 140 may access server 150 using private or public APIs (application programming interfaces).

Referring to the step 540 of obtaining allocation information, the instructions when executed may cause processor(s) 250, server processor(s) 620, device processor(s) 850, and/or microcontroller(s) 340 to display on a display 220 of computing device 110 (or on a display of another device (e.g., a mobile device, computer, tablet, etc.) by which a graphical user interface of an application hosted by server 140, such as the financial application described above, is accessed) a prompt for the allocation information, which may be for a time period. As described above, this may include, as a non-limiting example, a monthly budget, such as a financial budget, or a power or energy consumption budget. Alternatively, the allocation information for the time period may be obtained over network 120 from server(s) 140. In another aspect, the instructions when executed may prompt for allocation information even where allocation information has been provided by server(s) 140, in which case the manually entered allocation information may override the allocation information obtained from server(s) 140.

The instructions when executed may further cause processor(s) 250, server processor(s) 620, device processor(s) 850, and/or microcontroller(s) 340 to determine one or more savings options for meeting the allocation, each of the savings option(s) comprising one or more altered usage pattern(s) for the network-connected device(s) 130. In the example scenario described above, where the allocation is a budget manually entered or obtained or received from a financial server 140, or an inputted power or energy consumption budget, an altered usage pattern of a savings option may comprise a reduced usage pattern for a lighting fixture and/or a washing machine, for example, in order to help maintain the allocation or budget for the relevant time period (e.g., a month).

A savings option may mean a savings with respect to usage that alone or in combination with other factors (e.g., other account data, such as monthly expenditures, not related to the usage of the network-connected device(s) 130) exceeds an allocation, or it may mean a savings with respect to usage that alone or in combination with other factors is under a minimum allocation. With respect to the latter, using the vehicle testing example described above, a network-connected device or vehicle 130 requiring as an allocation a certain minimum number of miles driven per day as part of road-testing, and which comes under or is on track to come under that minimum allocation or number of miles/day, may result in a savings option comprising an altered usage pattern having an increased usage of the vehicle per day.

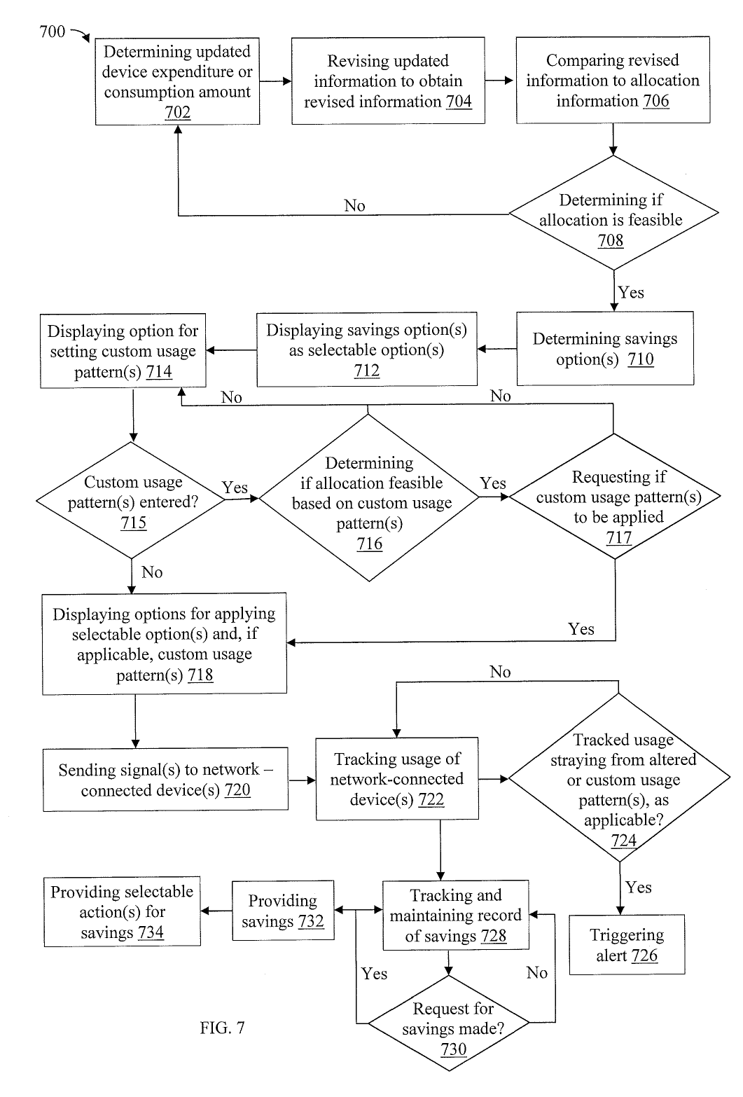

Referring to FIG. 7, the instructions when executed cause the processor(s) 250, server processor(s) 620, device processor(s) 850, and/or microcontroller(s) 340 to determine 710 each of the savings option(s) by carrying out steps of method 700, including: determining 702, for the network-connected device(s) 130, an updated device expenditure or consumption amount based on the rate data and the altered usage pattern(s); revising 704 the updated information (e.g., updated financial information, or updated power or energy consumption information) with the updated device expenditure or consumption amount for the network-connected device(s), to obtain revised information (e.g., revised financial information, or revised power or energy consumption information); comparing 706 the revised information (e.g., revised financial information, or revised power or energy consumption information) to the allocation information; and determining 708, based on the comparison of the revised information (e.g., revised financial information, or revised power or energy consumption information) to the allocation information, if the allocation for the time period is feasible. Where it is determined that the allocation for the time period would not be feasible, method 700 may return to step 702 to begin method 700 again based on one or more other altered usage pattern(s). Each of the savings options comprises one or more of the altered usage pattern(s) for which it is determined that the allocation for the time period is feasible. An allocation determined to be feasible for a time period is an allocation that is expected to be able to be met or achieved for that time period.

For example, one savings option may include a reduced usage pattern for a light fixture, another savings option may include a reduced usage pattern for a dishwasher, and yet another savings option may include a reduced usage pattern for both the light fixture and the dishwasher. The combined reduced usage pattern may represent the sum of the individual reduced usage patterns comprising the individual savings options for those devices, or some other reduction in usage. For example, an altered usage pattern comprising a combined reduced usage for a plurality of devices may represent a total reduction in usage that is the same or similar in amount to a savings option having an altered (e.g., reduced) usage pattern for only a single network-connected device 130, to distribute the burden of reducing usage amongst the network-connected devices 130 covered by the combined savings option to thereby lessen the extent of reduced usage for each device individually. A variance from the allocation may also be determined and displayed in real-time upon the selection of one or more of the savings option(s) (e.g., an expected total monthly expenditure or consumption amount based on the selected savings option(s) and possibly other factors (e.g., other account data, such as monthly expenditures, not related to the usage of the network-connected device(s) 130)).

The instructions when executed may further cause the processor(s) 250, server processor(s) 620, device processor(s) 850, and/or microcontroller(s) 340 to display 712 on display 220 of computing device 110 (or on a display of another device (e.g., a mobile device, computer, tablet, etc.) by which a graphical user interface of an application hosted by server(s) 140, such as the financial application described above, is accessed) the one or more savings options as selectable options, and optionally, may further cause to be displayed 714 an option for manually setting one or more custom usage patterns for at least one of the network-connected device(s) 130. At step 715, it is determined if a custom usage pattern(s) is manually entered, and if not, method 700 may proceed to step 718. Where one or more custom usage pattern(s) are entered, the instructions, when executed, may further cause the processor(s) 250, server processor(s) 620, device processor(s) 850, and/or microcontroller(s) 340, for each of the network-connected device(s) 130 for which a respective custom usage pattern is manually set, to determine 716 substantially in real-time upon the manual setting of the respective custom usage pattern, if the allocation for the time period is feasible by use of the respective custom usage pattern. A variance from the allocation may also be determined and displayed in real-time upon the setting of one or more custom usage pattern(s), as described above with respect to the selection of savings option(s). If it is determined that the allocation is not feasible using a custom usage pattern, method 700 may return to step 714, and where it is determined that the allocation is feasible using the custom usage pattern, the instructions when executed may further cause to be displayed a prompt requesting 717 if the custom usage pattern is to be applied. Where the custom usage pattern is to be applied, method 700 may proceed to step 718, and where the custom usage pattern is not to be applied, method 700 may return to step 714.

Further, the instructions when executed may also cause to be displayed 718 options for applying each of the selectable options and, where applicable, manually set custom usage pattern(s). Such options may include, for example, applying the selected savings option(s) and/or custom usage pattern(s) for a single time period (e.g., the current month only, the next month only, the current week only, etc.), or on a recurring basis, with or without an end date (e.g. monthly and indefinitely, or monthly until a specific date, or monthly with a number of months specified, etc.). Such options may also include applying multiple savings options in a default order or prioritized list that is displayed, or alternatively, according to another order representing a prioritized list manually set by a user, as would be applicable where the user wishes to apply a plurality of savings options but not in parallel, such that only one savings option is applied at any one time. As not all network-connected devices run in an “always on” state (as further described below), the instructions when executed may apply the selected savings option(s) and/or custom usage pattern(s) to a prioritized device 130 when it is on, and when it is off, apply any applicable savings option(s) and/or custom usage pattern(s) to a device 130 that is on (whether running in an “always on” state, or manually turned on for a time period) and that is next in priority in the default or manually set prioritized list.

When a selection of any of the savings option(s) and/or the custom usage pattern(s) is received, the instructions when executed may further cause the processor(s) 250, server processor(s) 620, device processor(s) 850, and/or microcontroller(s) 340 to send 720 via a communication module over network 120 a signal to each of the network-connected device(s) 130 affected by the selected savings option(s) and/or custom usage pattern(s). Each of the signals causes each of the affected network-connected devices to operate in accordance with the respective altered usage pattern or custom usage pattern, as applicable, that has been selected, as well as in accordance with any selected options for applying the savings option(s) and/or custom usage pattern(s), as described above. For example, upon the selection of a savings option to reduce a network-connected thermostat temperature by 1° F. for a month, a signal carrying instructions for the altered usage pattern would be formed in a language understandable by a processor or microcontroller of the thermostat, and transmitted to the thermostat, which would then process the instructions and accordingly alter its temperature setting for a month.

Alternatively, or additionally, the savings option(s) and/or custom usage pattern(s), when selected, may result in the instructions, when executed by the processor(s), causing usage of the affected device(s) 130 to be tracked 722 against the selected altered or custom usage pattern(s). Where it is determined 724 that usage of the tracked device(s) strays from the altered or custom usage pattern(s) selected, the instructions when executed may further trigger an alert 726 which indicates that usage is above (or below, if applicable) a target usage (i.e., the altered or custom usage pattern). The alert may comprise, for example, an audible and/or visual alert displayed on a display 220 (or on a display of another device (e.g., a mobile device, computer, tablet, etc.) by which a graphical user interface of an application hosted by server(s) 140, such as the financial application described above, is accessed) or a message sent via communication module to a digital address of a user of computing device(s) 110, smart sensor(s) 300, network-connected device(s) 130, and/or server(s) 140 (e.g., SMS, MMS, instant message, email, a proprietary message type, etc.). It will be appreciated by the person skilled in the art that any suitable type of alert or alert message may be used.

The instructions when executed may further cause the processor(s) 250, server processor(s) 620, device processor(s) 850, and/or microcontroller(s) 340 to track and maintain 728 a record, in memory 200, 610, 800, and/or 330 of savings resulting from the selection of any of the savings option(s) and/or the custom usage pattern(s). As such, it is expected that a user may request from computing device 110 and/or server(s) 140 real-time savings data relating to the usage of one or more network-connected device(s) 130 in accordance with one or more altered and/or custom usage pattern(s). Where it is determined 730 that a request for real-time savings data has been made, the instructions when executed may cause the savings to be provided 732 in real-time, upon request 730, such as by being displayed on display 220 of computing device 110 (or on a display of another device (e.g., a mobile device, computer, tablet, etc.) by which a graphical user interface of an application hosted by server(s) 140, such as the financial application described above, is accessed). It will be appreciated that where it is described herein that information is displayed on display 220 or some other display, the present application is not to be limited by the described mode of presentation, and that other means for presenting information, such as by text or audio messaging, may be used. Furthermore, input(s) need not be via touch-sensitive display, but may alternatively, or additionally, comprise input by text entry, messaging, audio (e.g., voice command), and any other suitable means for carrying out method step(s) described herein.

The instructions when executed by the processor(s) may further cause the processor(s) 250, server processor(s) 620, device processor(s) 850, and/or microcontroller(s) 340 to provide 734, such as by displaying on display 220 (or on a display of another device (e.g., a mobile device, computer, tablet, etc.) by which a graphical user interface of an application hosted by server(s) 140, such as the financial application described above, is accessed), one or more selectable actions for the savings resulting from the selection of any of the savings option(s) and/or custom usage pattern(s). The selectable action(s) may include, for example, where the savings are financial savings, depositing the savings into one or more of the account(s) via server 140 (e.g., financial server 140). For example, a user may select an action comprising the deposit of savings into a savings account, a chequing account, an education savings fund, an investment instrument, and so on.

The instructions when executed by the processor(s) may cause processor(s) 620 to update the information (e.g., financial information, or power or energy consumption information) to account for the altered and/or custom usage pattern(s) selected. As such, expenditure amounts associated with the altered and/or custom usage pattern(s) may be reflected in any future report(s), chart(s) or other format for data presentation (e.g., a power or energy usage report, or a financial report) produced by an application (e.g., a financial application) hosted by server(s) 140.

Referring to FIG. 9, in accordance with another exemplary aspect of the present application, the instructions when executed by any suitable combination of the processor(s) of computing device(s) 110, server(s) 140, network-connected device(s) 130, and/or smart sensor(s) 300 cause the processor(s) to carry out steps of method 900, for managing usage of network-connected device(s) 130 over network 120. Method 900 comprises determining 902, for at least one of the network-connected device(s) 130, altered device setting(s) feasible for an allocation amount relating to the network-connected device(s) 130. The allocation amount may pertain to a time period, and is as described herein with respect to allocations or allocation information (the terms allocation amount, allocation and allocation information are used herein interchangeably). An allocation amount may comprise, for example, a financial budget, a power consumption budget, or an energy consumption budget, and may represent an upper or a lower limit, as previously described. Further, the allocation amount and the feasibility of the allocation amount in view of altered device setting(s) may be determined by any method described herein with respect to allocations or allocation information, such as method 500 and/or method 700. The allocation amount may also be input by a user of system 100 via any suitable input interface or device of computing device(s) 110, server(s) 140, network-connected device(s) 130, and/or smart sensor(s) 300. Furthermore, the allocation amount may be determined by two or more factors. For example, an allocation may be established by specifying, for example, by an input device or interface of computing device(s) 110, server(s) 140, network-connected device(s) 130, and/or smart sensor(s) 300, two or more factors or parameters that are processed by the processor(s) to determine an allocation amount. Such factors may include, for example, an environmental condition, an extent of power or energy consumption, a financial expenditure, and any other factor that can have a bearing on the determination of an allocation amount of any type; the skilled person will appreciate that such factors may be extensive and are not to be limited to the specific examples set forth herein. As one example, it may be desired to cool a property by 20% (an environmental condition) to a maximum increase of 5% power consumption (an upper limit on power consumption). It may be pre-programmed or pre-determined (e.g., as a configurable setting) to apply the cumulative effect of the factors, or to apply the factors in an alternative fashion. The factors, taken together in the pre-determined manner (i.e., either cumulatively or alternatively) comprise the allocation amount.

The altered device setting(s) may be input by a user of system 100 via any suitable input interface or device of computing device(s) 110, server(s) 140, network-connected device(s) 130, and/or smart sensor(s) 300, or may be determined by the processor(s) of computing device(s) 110, server(s) 140, network-connected device(s) 130, and/or smart sensor(s) 300. For example, the altered device setting(s) may be determined as previously described herein in method 700, such as with respect to the steps of determining savings options(s) 710 and/or applying custom usage patterns) 717, 718, 720.

Method 900 further comprises sending signal(s) 904, via any suitable communication module(s) 210, 630, 310, and/or 810, over network 120, to each of the at least one of the network-connected device(s) 130 affected by the determined altered device setting(s).

Each signal causes each affected network-connected device 130 to operate in accordance with the respective altered device setting(s). For example, as described above with respect to method 700, upon the determination of altered device setting(s) (such as by the selection of a savings option) for reducing a network-connected thermostat temperature by 1° F. for a month, a signal carrying instructions for the altered device setting(s) would be formed in a language understandable by a processor or microcontroller of the thermostat, and transmitted to the thermostat, which would then process the instructions and accordingly alter its temperature setting for a month.

Once each affected network-connected device 130 is operating 906 in accordance with its respective altered device setting(s), adjustments may be made to either or both of the allocation amount and the device settings of any of the network-connected device(s) 130. For example, once each affected network-connected device 130 is operating 906 in accordance with its respective altered device setting(s), there may be an adjustment 908 of one or more device settings of one or more of the network-connected device(s) 130 (either manually, by a user, or autonomously by a device 130 in response, for example, to a changed environmental setting, such as a thermostat increasing its target temperature where the ambient temperature is dropping (should the device be programmed for autonomous adjustments)). If it is determined 910 that the adjustment is such that the allocation amount is no longer feasible, it is determined 912 if a further adjustment of one or more others of the device setting(s) of the network-connected device(s) 130 can maintain feasibility of the allocation amount. If the allocation amount can be maintained by the further adjustment of one or more others of the device setting(s), the network-connected device(s) 130 (which may comprise only the network-connected device(s) 130 originally affected by the altered device setting(s), or may additionally comprise one or more other network-connected device(s) 130 also) operate 914 in accordance with the further adjusted one or more others of the device setting(s). An alert may also be generated 916 indicating that the network-connected device(s) 130 are operating in accordance with further adjusted device setting(s). Should the adjustment be such that the feasibility of the allocation amount cannot be maintained or met by the determined further adjustment, a variance from the allocation amount may be determined 918, and optionally, recorded. It may be pre-determined, for example as a configurable setting, to apply the further adjustment to maintain the allocation amount to the fullest extent possible, and to track the variance from the allocation amount from the point of further adjustment, or, to not apply the further adjustment where it is determined that the further adjustment would not maintain the feasibility of the allocation amount, and to track the variance from the network-connected device(s) 130 operating in accordance with the adjustment 908. The further adjustment may be applied or executed by the processor(s) automatically, upon its determination, to the device setting(s) of the network-connected device(s) 130, substantially in real-time. Alternatively, the processor(s) may prompt for input to execute, deny or override the determined further adjustment by any suitable input interface or device of computing device(s) 110, server(s) 140, network-connected device(s) 130, and/or smart sensor(s) 300. Whether the processor(s) apply the further adjustment automatically or prompt for input with respect thereto may be pre-determined as a configurable setting.

Further, the instructions when executed may generate 916 an alert when the variance is determined. The alert may indicate that the allocation amount cannot be met and/or the variance from the allocation amount, and may also include an indication that the network-connected device(s) 130 are operating in accordance with further adjusted device setting(s), as described above. The alert may comprise, for example, an audible and/or visual alert displayed on a display 220 (or on a display of another device (e.g., a mobile device, computer, tablet, etc.) by which a graphical user interface of an application hosted by server(s) 140, such as the financial application described above, is accessed) or a message sent via communication module to a digital address of a user of computing device(s) 110, smart sensor(s) 300, network-connected device(s) 130, and/or server 140 (e.g., SMS, MMS, instant message, email, a proprietary message type, etc.). It will be appreciated by the person skilled in the art that any suitable type of alert or alert message may be used.

The determination of the other(s) of the device setting(s) of the network-connected device(s) 130 to be further adjusted to maintain feasibility of the allocation amount may be based on one or more criteria, which may be pre-determined. For example, such criteria may comprise: adjustment limit(s) of the network-connected device(s) 130 (e.g., a thermostat may not be increased beyond a certain temperature); location(s) of the network-connected device(s) 130 (including geographic coordinates, which determines the current season (i.e., winter, summer, fall, or spring) and whether it is night or day, which are factors that may have a bearing on certain allocations; and, location within a property (to avoid, e.g., turning off lights in heavily used areas of a house during high-occupancy times, e.g., the kitchen lights at 7 pm, in order to reduce power consumption and/or financial expenditures); environmental condition(s) of the network-connected device(s) (e.g., weather conditions, whether the device(s) are in shaded or sunny areas, etc.); power consumption of the network-connected device(s) (i.e., high versus lower power consumption devices); financial cost of operating the network-connected device(s); thermal output of the network-connected device(s) (e.g., a fireplace, having a high thermal output when activated, would not be turned on when trying to reduce a home's temperature); and/or user-defined preferences for the network-connected device(s). The user-defined preferences may include, for example, a default priority of devices for which to alter device settings in order to make feasible an allocation, network-connected device(s) 130 to not alter at all, maximum or minimum amounts of adjustments that any network-connected device(s) 130 may undergo in order to make an allocation feasible, and any other type of user-defined preference which may have a bearing on making allocations feasible.

Still with reference to FIG. 9, the instructions when executed may, upon an update 920 to the allocation amount (either by receipt of an updated allocation amount by any suitable input interface or device of computing device(s) 110, server(s) 140, network-connected device(s) 130, and/or smart sensor(s) 300, or by receiving an updated allocation in accordance with method 500, described above), determine 922, substantially in real-time, for a further at least one of the network-connected device(s) 130, further altered device setting(s) feasible for the updated allocation amount, after which method 900 may return to step 906.

In accordance with another aspect of the present application, network-connected device(s) 130 may be connected to each other in a peer-to-peer manner, thereby forming a peer-to-peer (P2P) network of connected devices, such as a P2P network of Internet-of-Things (IoT) devices 130. In yet a further aspect of the present application, the further adjustment of the one or more others of the device setting(s) of the network-connected device(s) 130 for maintaining feasibility of the allocation amount may be determined, and further may be executed, by the instructions when executed by the device processor(s) of the one or more of the network-connected device(s) 130 for which the device setting(s) are adjusted.

In an example scenario, where the allocation amount is comprised of the factors of cooling a property by 20% to a maximum increase of 5% power consumption, the instructions when processed by any suitable processor(s) may determine that: a front window will not be opened, as it is in located a sun-exposed and hot area (which may be detected by a sensor of the window, or which may be preprogrammed into instructions for execution by any suitable processor(s), including device processor(s) 850 of the window) and opening the window may result in the movement of heat into the property; a fireplace will not be activated, as it would increase heat in the property; a window at the rear of a house, located in a shaded area may be opened to its maximum adjustment limit of 100% open, which is determined to involve an increase in power consumption of 0.1%, but which is not itself capable of reducing the property temperature by 20%; a thermostat, which may be preprogrammed as a lower priority device for being subjected to altered device setting(s) as compared to the property windows, may then be adjusted to set a target temperature that is 2° C. cooler, which adjustment comprises an increase in power consumption of 3.0% and, taken together with the opening of the window at the rear of the house, result in a 20% cooling of the property. As these adjustments result in a power consumption increase of 3.1%, which is within the imposed 5% power consumption increase limit, they are permitted by the processor(s). Alternatively, it may be a pre-programmed, user-or system-defined preference to not open windows when air conditioning is activated, in which case, only the thermostat may be subjected to an altered device setting (e.g., the thermostat may then be adjusted to set a target temperature that is 3° C. cooler, which adjustment comprises an increase in power consumption of 3.5%, which results in a 20% cooling of the property while coming within the imposed 5% power consumption increase limit).

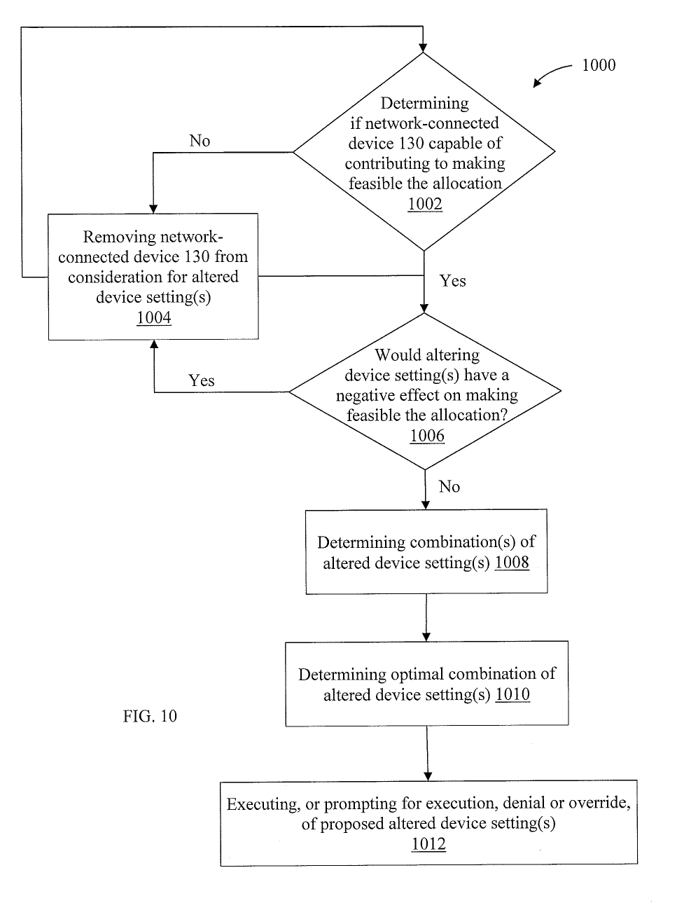

With reference to FIG. 10, in accordance with another exemplary aspect of the present application, the instructions when executed by any suitable combination of the processor(s) may carry out steps of method 1000. In one example aspect of the logic which may be employed in determining altered device setting(s) for making feasible an allocation, method 1000 may comprise determining 1002, for each network-connected device 130, if the network-connected device 130 is capable of contributing to the making feasible of an allocation (e.g., a fireplace cannot contribute to making feasible an allocation comprising the reduction of a property temperature by 2° C., while a window potentially can); if it is not capable of contributing to the making feasible of the allocation, that device 130 is removed 1004 from consideration for altered device setting(s), and the analysis returns to step 1002 for a next device 130. This process may repeat until all network-connected device(s) 130 have been assessed for their ability to contribute to making feasible the allocation. Once all network-connected device(s) 130 capable of contributing to making feasible the allocation are determined, method 1000 may proceed to determining 1006 if the altering of device setting(s) of each network-connected device 130 under consideration would have a negative effect on making feasible the allocation (e.g., opening a front window in a sun-exposed and hot area may have a negative effect on an allocation involving reducing property temperature by 2° C.); if adjustment of a device 130 would have a negative effect on making feasible the allocation, that device 130 is removed 1004 from consideration for altered device setting(s), and the analysis returns to step 1006 for a next device 130. This process may repeat until all network-connected device(s) 130 determined 1002 to be capable of contributing to making feasible the allocation have been assessed to determine 1006 if their effect on making feasible the allocation would be a negative one (i.e., would be counter-productive to making feasible the allocation). At step 1008, one or more combinations of altered device setting(s), for making feasible the allocation, for one or more of the network-connected device(s) 130 under consideration are determined. This may involve an assessment of the power consumption required by each network-connected device 130 under consideration in order to make feasible the allocation, either alone, or in combination with others of such device(s) 130 (various or all such combinations may be derived and assessed). Preference may be given to adjusting the lower power-consuming device(s) 130 over those requiring more power to effect the required alterations in their device settings, and an absolute power consumption may be determined having consideration to the extent to which the device setting(s) of each network-connected device 130 under consideration is required to be altered and the power consumption required to effect such altered device setting(s) (e.g., the power required to open a window to its 100% open position). Preference for determining the network-connected device(s) 130 to which to apply altered device setting(s) may also be given based on a priority ordering of the network-connected device(s) 130 for subjecting to altered device setting(s) (the priority may be a default setting or user-established, or there may be no priority for applying altered device setting(s) to the network-connected device(s) 130). At step 1010, the optimal combination of altered device setting(s) for making the allocation feasible is determined, and what constitutes an optimal combination may be pre-determined, as a configurable setting, and/or may be a default setting. As non-limiting examples, an optimal combination may comprise a combination of altered device setting(s) that is the least financially costly, least power- or energy-consuming, least disruptive to any one device 130, or some combination thereof. At 1012, the altered device setting(s) may be executed, substantially in real-time, by the processor(s), or a user may be prompted to execute, deny or override the proposed altered device setting(s), as described above.

It is expected that the described system(s), computing device(s) and method(s) may allow for real-time or substantially real-time monitoring of the usage of network-connected device(s) and to track such usage in real-time against an allocation. An expected advantage of the ability to acquire such usage information in real-time is that variances from an allocation (e.g. excessive usage of a washing machine in view of a monthly budget) may be adjusted in accordance with the allocation in an attempt to avoid, for example, spending more than the set budget. This is preferable to the approach of adjusting usage patterns only after, e.g., having been invoiced for the device usage, by which time the excess device use has already taken place, and the related costs have already been incurred. The aspects of the present application described and claimed herein are expected to provide information, from which it may be determined that adjustments in device usage may be required in order for an allocation to be feasible or to facilitate the feasibility of an allocation, sooner than would otherwise be possible. The described system(s), computing device(s) and method(s) are also expected to facilitate the effective, timely and efficient managing of device settings of multiple network-connected devices in tandem in order to make feasible an allocation.

As used herein, including in the claims appended hereto, the terms “computing device”, “computing devices” or “computing device(s)” may include any combination of the described computing device(s) 110, network-connected device(s) 130, smart sensor(s) 300, and/or server(s) 140 that may be used to carry out method step(s) described herein.

While the foregoing has been described in some detail for purposes of clarity and understanding, it will be appreciated by those skilled in the relevant arts, once they have been made familiar with this disclosure, that various changes in form and detail can be made without departing from the true scope of the appended claims. The present application is therefore not to be limited to the exact components or details of methodology or construction set forth above.

Except to the extent necessary or inherent in the processes themselves, no particular order to steps or stages of methods or processes described in this disclosure, including in the Figures, is intended or implied. In many cases the order of process or method steps may be varied, and or made sequential or parallel, without changing the purpose, effect, or import of the method(s) described.

1. A computing device for managing usage of network-connected device(s) over a network, the computing device comprising:
a memory storing computer-executable instructions;
a communication module for communication with said network-connected device(s) via the network; and
at least one processor coupled to the memory and the communication module, the instructions when executed by the at least one processor causing the at least one processor to:
determine, for at least one of said network-connected device(s), altered device setting(s) feasible for an allocation amount relating to said network-connected device(s), the allocation amount pertaining to a time period; and
send, via the communication module, over the network, a signal to each of the at least one of said network-connected device(s) affected by said determined altered device setting(s), each said signal causing each said affected network-connected device to operate in accordance with the respective altered device setting(s),
wherein, once each said affected network-connected device is operating in accordance with said respective altered device setting(s), adjustment of one or more device settings of one or more of said network-connected device(s) such that the allocation amount is no longer feasible causes to be determined a further adjustment of one or more others of the device settings of said network-connected device(s) to maintain feasibility of the allocation amount,
wherein when an amount of the adjustment of the one or more device settings of the one or more of said network-connected device(s) is such that the allocation amount cannot be met by said determined further adjustment of the one or more others of the device settings of said network-connected device(s), a variance from the allocation amount is determined.

2. The computing device of claim 1 wherein the allocation amount comprises a financial budget, a power consumption budget, or an energy consumption budget.

3. The computing device of claim 1 wherein upon an update to the allocation amount, the instructions when executed by the at least one processor further cause the at least one processor to determine, substantially in real-time, for a further at least one of said network-connected device(s), further altered device setting(s) feasible for the updated allocation amount.

4. The computing device of claim 1 wherein when the variance from the allocation amount is determined, the instructions when executed by the at least one processor further cause the at least one processor to generate an alert indicating that the allocation amount cannot be met and/or the variance from the allocation amount.

5. The computing device of claim 1 wherein the instructions when executed by the at least one processor cause the at least one processor to either:
prompt for input to execute, deny or override said determined further adjustment; or
execute said determined further adjustment substantially in real-time.

6. The computing device of claim 1 wherein said network-connected device(s) are connected to each other in a peer-to-peer manner and each of said network-connected device(s) comprises:
a device memory storing computer-executable instructions;
a device communication module for communication with said computing device and one or more others of said network-connected device(s), via the network; and
at least one device processor coupled to the device memory and the device communication module,
wherein said further adjustment is determined and executed by the instructions when executed by the at least one device processor of said one or more of said network-connected device(s) for which said one or more device settings are adjusted.

7. The computing device of claim 1 wherein the determination of said one or more others of the device settings of said network-connected device(s) to be further adjusted to maintain the feasibility of the allocation amount is based on criteria comprising: adjustment limit(s) of said network-connected device(s); location(s) of said network-connected device(s); environmental condition(s) of said network-connected device(s); power consumption of said network-connected device(s); financial cost of operating said network-connected device(s); thermal output of said network-connected device(s); and/or user-defined preferences for said network-connected device(s).

8. The computing device of claim 1 wherein the allocation amount is determined by two or more factors.

9. A system for managing usage of network-connected device(s) over a network, the system comprising:
a computing device; and
the network-connected device(s);
the computing device comprising:
a memory storing computer-executable instructions;
a communication module for communication with said network-connected device(s) via the network; and
at least one processor coupled to the memory and the communication module, the instructions when executed by the at least one processor causing the at least one processor to:
determine, for at least one of said network-connected device(s), altered device setting(s) feasible for an allocation amount relating to said network-connected device(s), the allocation amount pertaining to a time period; and
send, via the communication module, over the network, a signal to each of the at least one of said network-connected device(s) affected by said determined altered device setting(s), each said signal causing each said affected network-connected device to operate in accordance with the respective altered device setting(s),
wherein, once each said affected network-connected device is operating in accordance with said respective altered device setting(s), adjustment of one or more device settings of one or more of said network-connected device(s) such that the allocation amount is no longer feasible causes to be determined a further adjustment of one or more others of the device settings of said network-connected device(s) to maintain feasibility of the allocation amount,
wherein when an amount of the adjustment of the one or more device settings of the one or more of said network-connected device(s) is such that the allocation amount cannot be met by said determined further adjustment of the one or more others of the device settings of said network-connected device(s), a variance from the allocation amount is determined,
and wherein said network-connected device(s) are connected to each other in a peer-to-peer manner, and each of said network-connected device(s) comprises:
a device memory storing computer-executable instructions;
a device communication module for communication with said computing device and one or more others of said network-connected device(s), via the network; and
at least one device processor coupled to the device memory and the device communication module,
wherein said further adjustment is determined and executed by the instructions when executed by the at least one device processor of said one or more of said network-connected device(s) for which said one or more device settings are adjusted.

10. A method for managing usage of network-connected device(s) over a network by a computing device, the computing device comprising at least one processor coupled to a memory and a communication module, the method comprising:
determining, for at least one of said network-connected device(s), altered device setting(s) feasible for an allocation amount relating to said network-connected device(s), the allocation amount pertaining to a time period; and
sending, via the communication module, over the network, a signal to each of the at least one of said network-connected device(s) affected by said determined altered device setting(s), each said signal causing each said affected network-connected device to operate in accordance with the respective altered device setting(s),
wherein, once each said affected network-connected device is operating in accordance with said respective altered device setting(s), adjustment of one or more device settings of one or more of said network-connected device(s) such that the allocation amount is no longer feasible causes to be determined a further adjustment of one or more others of the device settings of said network-connected device(s) to maintain feasibility of the allocation amount,
wherein when an amount of the adjustment of the one or more device settings of the one or more of said network-connected device(s) is such that the allocation amount cannot be met by said determined further adjustment of the one or more others of the device settings of said network-connected device(s), a variance from the allocation amount is determined.

11. The method of claim 10 wherein the allocation amount comprises a financial budget, a power consumption budget, or an energy consumption budget.

12. The method of claim 10 further comprising, upon an update to the allocation amount, determining, substantially in real-time, for a further at least one of said network-connected device(s), further altered device setting(s) feasible for the updated allocation amount.

13. The method of claim 10 further comprising generating an alert when the variance from the allocation amount is determined, the alert indicating that the allocation amount cannot be met and/or the variance from the allocation amount.

14. The method of claim 10 further comprising:
prompting for input to execute, deny or override said determined further adjustment; or
executing said determined further adjustment substantially in real-time.

15. The method of claim 10 wherein said network-connected device(s) are connected to each other in a peer-to-peer manner, and each of said network-connected device(s) comprises at least one device processor coupled to a device memory and a device communication module for communication with said computing device and one or more others of said network-connected device(s), via the network,
and wherein said further adjustment is determined and executed by the instructions when executed by the at least one device processor of said one or more of said network-connected device(s) for which said one or more device settings are adjusted.

16. The method of claim 10 wherein the determination of said one or more others of the device settings of said network-connected device(s) to be further adjusted to maintain the feasibility of the allocation amount is based on criteria comprising: adjustment limit(s) of said network-connected device(s); location(s) of said network-connected device(s); environmental condition(s) of said network-connected device(s); power consumption of said network-connected device(s); financial cost of operating said network-connected device(s); thermal output of said network-connected device(s); and/or user-defined preferences for said network-connected device(s).

17. The method of claim 10 wherein the allocation amount is determined by two or more factors.

18. A non-transitory computer-readable medium for managing usage of network-connected device(s) over a network, the computer-readable medium comprising computer-executable instructions for:
determining, for at least one of said network-connected device(s), altered device setting(s) feasible for an allocation amount relating to said network-connected device(s), the allocation amount pertaining to a time period; and
sending, over the network, a signal to each of the at least one of said network-connected device(s) affected by said determined altered device setting(s), each said signal causing each said affected network-connected device to operate in accordance with the respective altered device setting(s),
wherein, once each said affected network-connected device is operating in accordance with said respective altered device setting(s), adjustment of one or more device settings of one or more of said network-connected device(s) such that the allocation amount is no longer feasible causes to be determined a further adjustment of one or more others of the device settings of said network-connected device(s) to maintain feasibility of the allocation amount,
wherein when an amount of the adjustment of the one or more device settings of the one or more of said network-connected device(s) is such that the allocation amount cannot be met by said determined further adjustment of the one or more others of the device settings of said network-connected device(s), a variance from the allocation amount is determined.

19. The non-transitory computer-readable medium of claim 18, wherein the allocation amount comprises a financial budget, a power consumption budget, or an energy consumption budget.

20. The non-transitory computer-readable medium of claim 18, the computer-executable instructions further for, upon an update to the allocation amount, determining, substantially in real-time, for a further at least one of said network-connected device(s), further altered device setting(s) feasible for the updated allocation amount.
